(19) United States
(12) Patent Application Publication
(10) Pub. No.: US 2010/0221087 A1
(43) Pub. Date: Sep. 2, 2010

(54) Preload locking Wire Insert

(75) Inventor: James Patrick Gillis, Auburn Hills, MI (US)

Correspondence Address: HARNESS, DICKEY & PIERCE, P.L.C., P.O. BOX 828, BLOOMFIELD HILLS, MI, 48303, US

(73) Assignee: Spiralock Corporation, Madisn Heights, MI (US)

(21) Appl. No.: 12/087,283

(22) PCT Filed: Jan. 23, 2007
(86) PCT No.: PCT/US2007/001764

§ 371 Date: Jun. 30, 2008

(51) Int. Cl. F16B 37/12; B21D 11/14

(52) U.S. Cl. 411/438; 72/371

(57) ABSTRACT

A preload locking wire insert comprised of a unitary, coiled wire having a particular polygonal cross-section for use in combination with a threaded fastener and a complementary threaded bore in a work piece, wherein the wire insert provides a ramping surface which locks the threads of the fastener into place against the inner threaded wall of the bore in the work piece. A further embodiment provides for the wire insert to be threaded into the bore in either direction, with no regard to orientation, while still retaining the definitive locking aspect.

### FIELD

The present disclosure relates to fastener inserts and, more particularly, to preload locking inserts formed from hardened material such as stainless steel or other metal alloy, which are utilized in tapped holes.

### BACKGROUND

The statements in this section merely provide background information related to the present disclosure and may not constitute prior art. Fastener assemblies come in a variety of shapes, sizes, designs, and materials. Many fastening assemblies include not only a fastener such as a bolt, pin, or screw, but also include a fastener insert to be positioned within a tapped hole. One specific type of fastener insert useful in association with a threaded fastener is the helically coiled wire insert, as described in U.S. Pat. No. 2,672,070 entitled “Wire Coil Screw Thread Insert for Molded Material,” for example.

Generally speaking, tapped threads are strengthened due to the inherent strength of such helically coiled wire inserts.

Notwithstanding the utilization of these threaded inserts, additional locking performance of a threaded fastener's engagement within a tapped hole may be enhanced by means of specific locking thread construction, as described in U.S. Pat. Nos. 4,076,064 and 4,171,012. These prior art locking thread designs effectively utilize a ramped thread form to more evenly distribute the load over a longer length of engagement.

Although the prior art discloses a wide variety of different types of wire insert concepts, none teach or suggest incorporating a locking thread form for achieving the benefits of increased strength of the fastener and threaded hole. Furthermore, there is a lack in the art of a preload locking wire insert which may further provide for the insertion of the insert in either direction, without regard to orientation, while still retaining the locking capabilities on the wire insert disclosed herein.

### SUMMARY

Therefore, it is an object of the invention to provide a novel and improved self-locking threaded connection which is more reliable than heretofore known self-locking connections.

It is a further object of an additional embodiment of the present invention to provide a preload locking wire insert which is designed to be inserted into a threaded hole unidirectionally, which more evenly distributes the load over a given length of engagement.

It is a further object of an additional embodiment of the present invention to provide a further embodiment of the preload locking wire insert which may be inserted into a threaded hole in either direction, without regard to orientation, while still allowing a fastener to be locked there within.

A further object of the present invention is to provide a helical threaded insert which has a reduced cross-section created by a series of pinched coils, allowing for the prevailing torque capabilities of a threaded fastener within a threaded hole when placed in the threaded hole.

A further object of the present invention is that it does not cause damage to the work piece during installation, as by shaving or similar action.

These and other advantages of the present invention will become apparent from the drawings and detailed description of the invention provided below, describing a preload locking wire insert comprised of a unitary, extruded, and coiled wire having a particular polygonal cross-section for use in combination with a threaded fastener and a complementary threaded bore in a material, wherein the wire insert provides a ramping surface which locks the threads of a male fastener into place against the inner threaded wall of a bore in a given material. In a further embodiment, the particular cross-section provides for the wire insert to be threaded into the hole in either direction, with no regard to orientation, while still retaining the definitive locking aspect.

As detailed in the additional embodiments, the present invention may contain features such as installation-assisting notches and/or one or more prevailing torque locking coils, positioned along the length of the wire insert, which provide additional securement of the fastener within the threaded hole.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a pre-assembled perspective view showing the installation orientation of the wire insert, threaded fastener, and the receiving hole;

FIG. 2 is a post-assembled, cross-sectional view of a prior art wire insert, threaded fastener, and receiving hole similar to FIG. 1;

FIG. 3 is a perspective, isolated view of the preload locking wire insert embodying an installation notch;

FIG. 4 is a bottom view of the locking wire insert of FIG. 3;

FIG. 5 is a perspective, isolated view of the preload locking wire insert, illustrating the cross-section of the wire which provides the locking means;

FIG. 5A is a perspective, isolated view of the preload locking wire insert, illustrating a plurality of prevailing torque locking coils in association therewith;

FIG. 5B is an aerial view of the prevailing torque locking ring elements of FIG. 5A;

FIG. 6 is a cross-sectional view of the extruded wire insert, as shown, prior to coiling;

FIG. 7 is a cross-sectional view of the wire insert, after coiling, yielding the locking design of the wire insert;

FIG. 8 is a partial cross-sectional side view of the preload locking wire insert positioned within a threaded hole in a work piece;

FIG. 9 is a partial cross-sectional side view of the preload locking wire insert positioned within a threaded hole in a work piece in conjunction with a threaded fastener prior to tightening;

FIG. 10 is a partial cross-sectional side view of the preload locking wire insert positioned within a threaded hole in a work piece in conjunction with a threaded fastener after tightening the fastener down, locking the fastener into place;

FIG. 11A is a perspective, isolated view of the bi-directional, preload locking wire insert embodying an installation notch; and

FIG. 11B is a cross-sectional side view of the bi-directional locking wire insert of FIG. 11A.

### DETAILED DESCRIPTION

The following description is merely exemplary in nature and is not intended to limit the present disclosure, application, or uses. It should be understood that, throughout the drawings, corresponding reference numerals indicate like or corresponding parts and features.

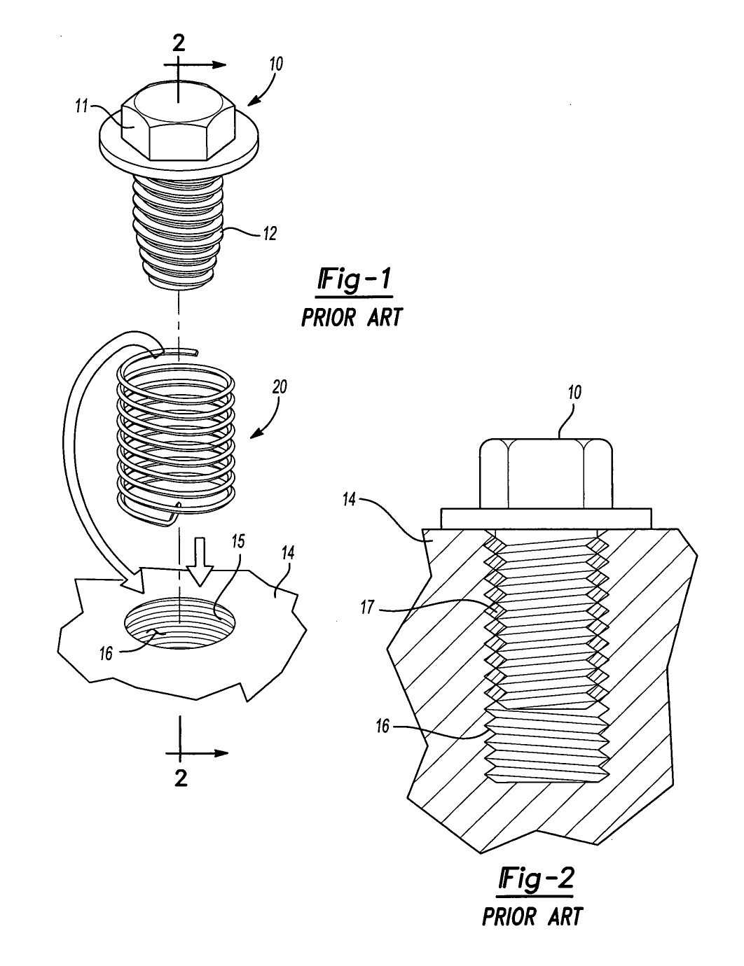

Referring now to the figures, in particular to FIG. 1, the preload locking wire insert 20, threaded fastener 10, and receiving hole 15 within a given work piece 14 are shown prior to assemblage. The receiving hole 15, within which the locking insert may be utilized, may be within any type of medium, but generally aluminum, titanium, or steel alloys thereof will be discussed herein. The receiving hole 15 comprises a series of bored-out threads 16 within the inner wall, corresponding to the pitch of the wire insert 20 and threaded shank 12 of the threaded fastener. As illustrated in this figure and shown in further detail in FIGS. 11A and 11B, one embodiment of the present invention is shown which provides for the wire insert 20 to be orientated in either direction with regard to the fastener 10 and the hole 15.

Prior art wire inserts 17, as illustrated in FIG. 2, generally have a symmetrical cross-section comprised of a diamond-shape. Although these fasteners may assist in securing the fastener to a work piece 14, they do not provide the additional locking feature provided by the particular design of the present invention, and thus fail to achieve the objectives accomplished by this invention.

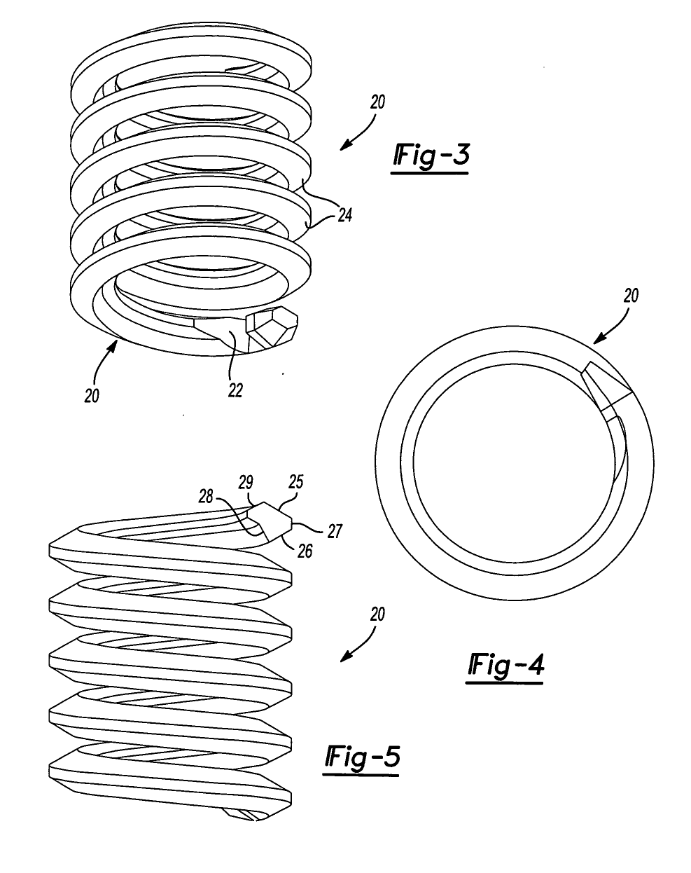

As shown in FIGS. 3 and 4, additional embodiments of the present invention may include a notch 22 proximal one or both ends of the wire insert 20. This notch allows for simplified installation of the wire insert within the hole of a work piece, prior to the installation of a male threaded fastener. The series of coils 24 can be comprised of any number, depending upon the particular application with which the insert 20 is utilized, and the coils 24 are subsequently turned to yield a particular pitch for the insert 20, corresponding to the pitch of the threads 16 within the hole 15 and the threads 12 on the fastener 10.

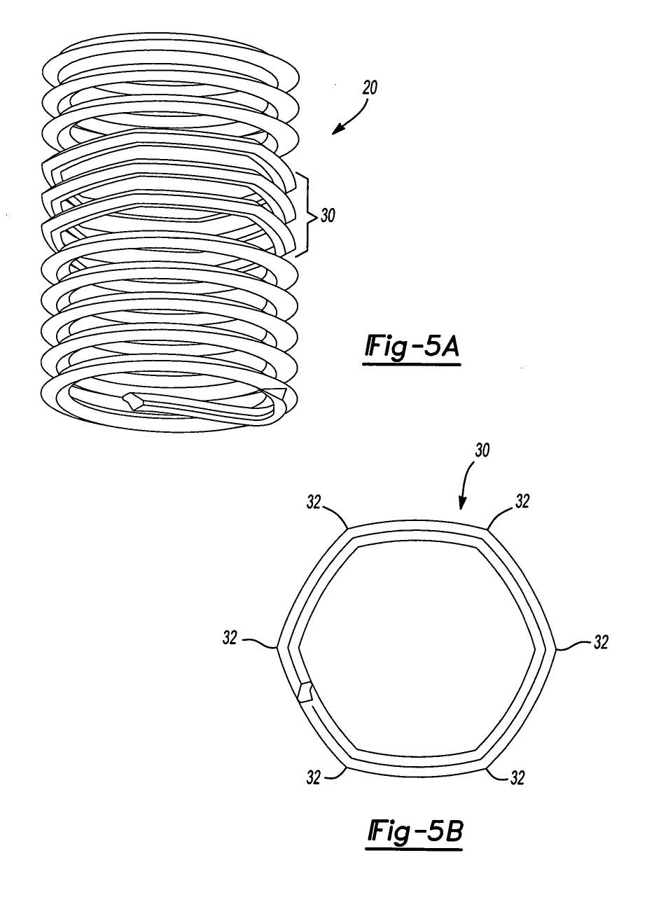

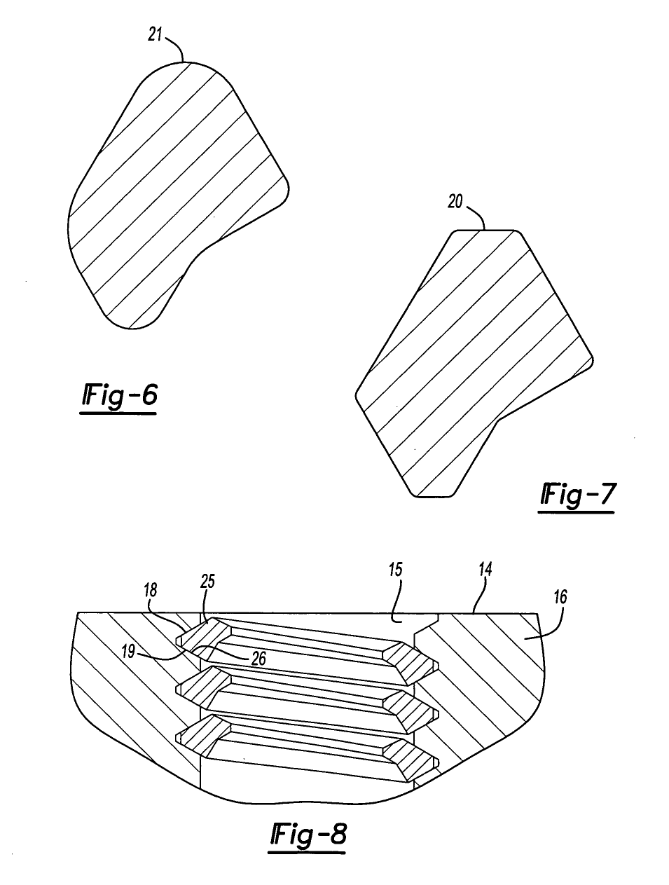

Referring now to FIGS. 5, 6, and 7 together, the cross-section of the preload locking wire insert 20 is shown, illustrating the particular design which yields the locking capabilities of the insert 20. The insert prior to coiling is of a generally oblong cross-section 21 as shown in FIG. 6, created by extruding the wire by means of a roll-extrusion process. Once the wire is extruded, the distinctive final cross-section of insert 20, as shown in FIG. 7, is formed by coiling the wire, yielding the end result illustrated in FIG. 5. The extrusion and coiling processes yield the definitive cross-section of the insert 20, comprising an upper thread surface 25, a lower thread surface 26, a major diameter 27, an inner lower fastener cooperating surface 28, and an inner upper fastener cooperating surface 29.

The particular positioning of the preload locking wire insert 20 can be shown in place within the hole 15 of work piece 14 in FIG. 8. The inner walls of the hole 15 comprise a plurality of threads 16 bored or molded therein. Each thread 16 comprises lower beveled surface 19 and an upper beveled surface 18. When wire insert 20 is inserted within the hole 15, the upper thread surface 25 of each coil 24 of the insert 20 cooperates with upper beveled surface 18 of thread 16, and the lower thread surface 26 cooperates with lower beveled surface 19, creating a snug fit of insert 20 within the hole 15.

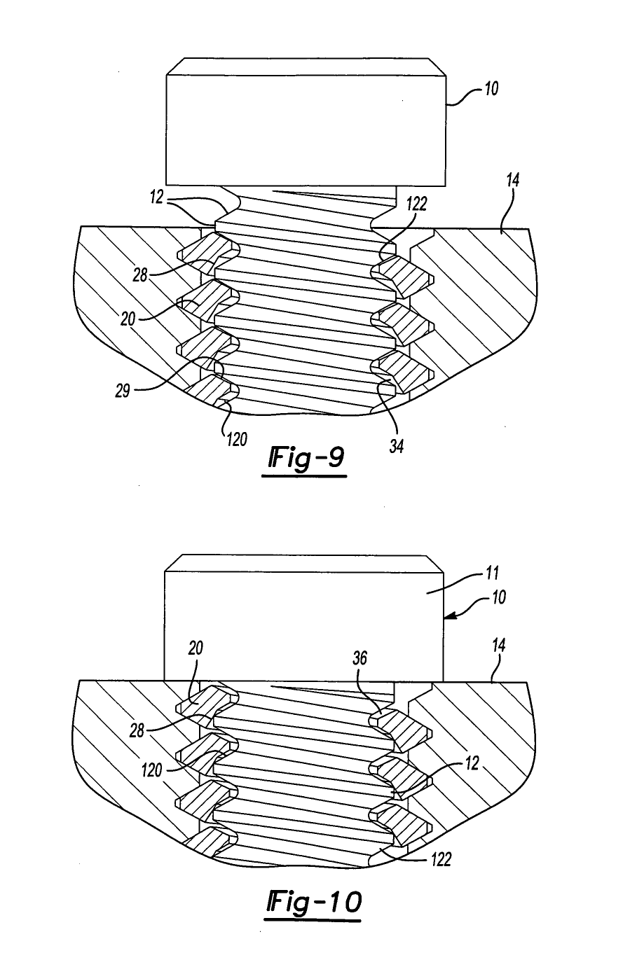

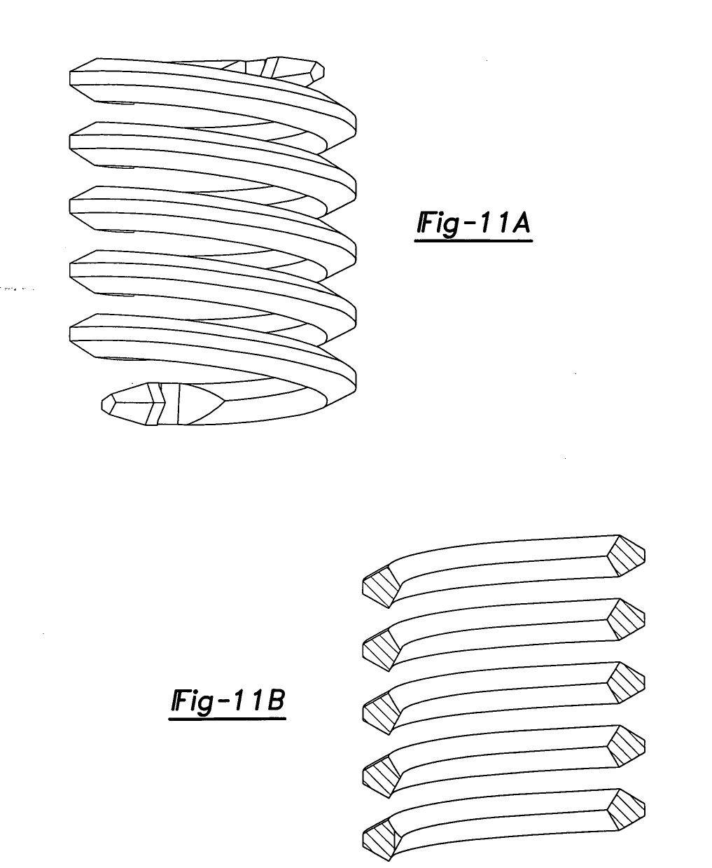

Referring now to FIGS. 9 and 10, threaded fastener 10 is shown partially inserted and fully inserted and tightened down, respectively, locking the fastener in place with the insert 20. With the wire insert 20 already in place within hole 15, the fastener 10 is threaded into the insert, whereby the upper thread surface 120 of the threads 12 of fastener 10 slidingly engage the inner, upper fastener cooperating surface 29 of the insert as shown in FIG. 9. A small gap 34 remains between the upper thread surface 120 of the threads 12 and the lower fastener cooperating surface 28 of the insert, which indicates the fastener 10 is not locked into place and further allows for the ease of inserting the fastener into the insert. Once the fastener 10 is fully inserted, illustrated by FIG. 10, additional torquing of the fastener head 11 locks the fastener into place by means of upward force imposed upon lower fastener cooperating surface 28 of the insert by upper thread surface 120 of the threads 12. The ramping force of upper thread surface 120 upon the lower fastener cooperating surface 28 creates a radially outward projected force of the insert 20, which frictionally locks into threads 16 of the hole 15 in the work piece 14.

When fully locked into place, a small gap 36 remains between the lower thread surface 122 of threads 12 and the upper fastener cooperating surface 29 of the insert. It is pertinent to restate that, because the wire insert 20 of this embodiment may be inserted into the hole in either orientation while retaining the locking features of its design, the numerals indicating the upper and lower surface of the wire insert 29, 28 would be reversed, in regard to interacting with the surfaces of thread 16 on the inside of the hole, as well as the thread surfaces of fastener 10.

A further embodiment of the present invention is shown in FIGS. 5A and 5B, wherein at least one prevailing torque locking coil 30 may be positioned among the standard coils 24. These prevailing torque locking coils 30 are created post-extrusion of the wire insert, during or after coiling, and comprise a series of pinched corners 32, which create generally linear sections of the wire there between. These linear sections create additional frictional force against the threads 12 of the fastener, while the pinched corners 32 create additional frictional force against the inner walls of hole 15. In conjunction with the locking features outlined above, additional securement of the fastener 10 and insert 20 within the hole 15 of the work piece 14 is achieved.

In a further embodiment of the present invention, it is to be noted that the wire insert 20 may be coated in one or more of a plurality of materials including, but not limited to, silver, cadmium, or a solid film lubricant prior to installation.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A preload locking helical wire insert utilized in combination with a threaded fastener and complementary internally threaded bore within a work piece, locking said threaded fastener into said bore, comprising:
a coiled wire having a pitch complementary to the pitch of the threads on said fastener and the pitch of the threads on said threaded bore, said insert having a polygonal cross-section of seven sides,
wherein when said insert is threaded into said bore, two generally converging sides of said wire simultaneously slidingly abut both the upper and lower flank surfaces between the crest and valley of the internal threads on said threaded bore of said work piece, and at least two generally converging sides extending inward radially meshingly interact with the threads of said threaded fastener; said inward converging sides having a converging angle less than the diverging angle between two adjacent threads on said fastener, yielding a small gap between the lower inward converging side of said insert and the upper flank surface between the crest and valley of the external threads of said fastener, while the lower flank surface between the crest and valley of external threads on said fastener slidingly abut the upper inward converging side of said insert while said fastener is being threaded into said bore, until a threshold torsional force is met by said fastener, wherein additional torsional force during the insertion of said fastener results in the crest of said external threads on said fastener ramping up said lower inward converging side of said fastener to a point where additional torsional force applied to said fastener results in no further movement of said fastener and insert.

2. The preload locking helical wire insert set forth in claim 1, wherein said insert is unidirectional, having a drive notch proximal one end for inserting into said threaded bore.

3. The preload locking helical wire insert set forth in claim 1, wherein said insert is bi-directional and may be threaded into said bore in either direction.

4. The preload locking, bi-directional helical wire insert of claim 3, wherein said insert is formed from at least one of the following materials: stainless steel, inconel, phosphor bronze, copper, or titanium.

5. The preload locking helical wire insert set forth in claim 1, wherein said insert further comprises at least one locking coil, said locking coil comprising one complete helix of said insert, having a generally hexagonal shape, yielding increased pressure points on said fastener and said threaded bore.

6. The preload locking bi-directional helical wire insert set forth in claim 3, wherein said insert further comprises at least one locking coil, said locking coil comprising one complete helix of said insert, having a generally hexagonal shape, yielding increased pressure points on said fastener and said threaded bore.

7. The preload locking, bi-directional helical wire insert of claim 6, wherein said insert is formed from at least one of the following materials: stainless steel, inconel, phosphor bronze, copper, or titanium.

8. The preload locking, bi-directional helical wire insert of claim 7, wherein said insert is removeable once threadably locked into said threaded bore.

9. A method of manufacturing a preload locking helical wire insert utilized in combination with a threaded fastener and complementary internally threaded bore within a work piece, locking said threaded fastener into said bore, comprising the steps of:
(a) providing a wire;
(b) forming said wire through extrusion to a wire having a polygonal cross-section of seven sides; and
(c) coiling said wire to a predetermined pitch.

10. The method of manufacturing a preload locking helical wire insert as outlined in claim 8, further comprising the step of cold stamping a plurality of detents in a predetermined length of said wire, which would compose at least one complete helix of said wire insert, creating at least one generally polygonal fastener prevailing torque locking coil during said wire coiling.

11. The preload locking, bi-directional helical wire insert of claim 7, wherein said insert is coated in at least one of the following materials: silver, cadmium, or solid film lubricant.

12. The method of manufacturing a preload locking helical wire insert as outlined in claim 10, further comprising the step of coating said wire insert in at least one of the following materials: silver, cadmium, or solid film lubricant.
